(19) United States
(12) Patent Application Publication
(10) Pub. No.: US 2015/0236911 A1
(43) Pub. Date: Aug. 20, 2015

(54) DETECTING CHARACTERISTICS OF A DATA PATH LOOP ON A NETWORK

(71) Applicant: Aruba Networks, Inc., Sunnyvale, CA (US)

(72) Inventors: Sandeep Unnimadhavan, Bangalore (IN); Santashil PalChaudhuri, West Bengal (IN)

(73) Assignee: Aruba Networks, Inc., Sunnyvale, CA (US)

(21) Appl. No.: 14/183,392

(22) Filed: Feb. 18, 2014

(51) Int. Cl. H04L 12/24

(52) U.S. Cl. CPC H04L 41/0866

(57) ABSTRACT

Methods and systems are described for detecting data path loops between ports on a device in a network system. Data path loops may be detected by first detecting data path loop characteristics exhibited by ports on a device. Upon detection of data path loop characteristics, the existence of a data path loop may be verified through the transmission of a broadcast packet through the potentially loopy ports. By first detecting characteristics of a data path loop and thereafter confirming the presence of a loop, the methods and systems described herein ensure that anomalies in data packet and/or port movement are not the product of configuration changes in the network system, but are instead the result of data path loops. By more intelligently identifying data path loops, false positives may be reduced.

### TECHNICAL FIELD

The present disclosure relates to the detection and handling of data path loops in a switching data network by monitoring potentially loopy ports and utilizing one port in a set of loopy ports for load balancing between multiple devices.

### BACKGROUND

Over the last decade, there has been a substantial increase in the use and deployment of network devices. For example, smartphones, laptop computers, desktop computers, tablet computers, and smart appliances may each communicate over wired and/or wireless switching networks. Each network device may map a port to each other device on a network such that data communications are performed through assigned ports.

Careless and/or inconsistent mapping of ports in a switching network may create loops between network devices. These loops may in turn facilitate broadcast storms in which the entire network may be rendered un-usable. Traditionally, network protocols (e.g., the Spanning Tree Protocol (STP)) are slow and inefficient in the detection of loops and require the injection of packets into the network for loop detection. Further, conventional methods have no mechanism by which to efficiently operate in an environment where a data loop has been detected. In particular, upon detecting a data path loop on a network, conventional systems simply block all transmissions on one or more loopy ports so that the loop in the data path is terminated. However, this technique is not ideal as non-looped transmissions are also blocked.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 shows a block diagram example of a network system in accordance with one or more embodiments;

FIG. 2A shows an exemplary bridge table for a network device with entries corresponding to each other device in a network system in accordance with one or more embodiments;

FIG. 2B shows an exemplary bridge table for the network device after a port move occurred in accordance with one or more embodiments;

FIG. 2C shows an exemplary bridge table for the network device after a set of ports have been marked as exhibiting characteristics of a data path loop in accordance with one or more embodiments;

FIG. 2D shows an exemplary bridge table for the network device after a set of ports have been marked as loopy in accordance with one or more embodiments;

FIG. 2E shows an exemplary bridge table for the network device after a favored loopy port has been selected for each entry in the table in accordance with one or more embodiments;

FIG. 3 shows a block diagram example of a network device in accordance with one or more embodiments;

FIG. 4 shows a method for detecting characteristics of a data path loop in the network system in accordance with one or more embodiments;

FIG. 5A shows example data stored for a first data packet and a second data packet in accordance with one or more embodiments;

FIG. 5B shows example data stored for a first data packet and a second data packet in accordance with one or more embodiments;

FIG. 5C shows example data stored for a first data packet and a second data packet in accordance with one or more embodiments;

FIG. 6 shows a method for confirming that the network system includes a data path loop in accordance with one or more embodiments;

FIG. 7 shows a method for handling communications received on a loopy port on a device in accordance with one or more embodiments; and

FIG. 8 shows a method for handling transmission of a broadcast packet received by a network device in which a set of loopy ports have been detected in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

Herein, certain terminology is used to describe features for embodiments of the disclosure. For example, the term “digital device” generally refers to any hardware device that includes processing circuitry running at least one process adapted to control the flow of traffic into the device. Examples of digital devices include a computer, a tablet, a laptop, a desktop, a netbook, a server, a web server, an authentication server, an authentication-authorization-accounting (AAA) server, a Domain Name System (DNS) server, a Dynamic Host Configuration Protocol (DHCP) server, an Internet Protocol (IP) server, a Virtual Private Network (VPN) server, a network policy server, a mainframe, a television, a content receiver, a set-top box, a video gaming console, a television peripheral, a printer, a mobile handset, a smartphone, a personal digital assistant “PDA”, a wireless receiver and/or transmitter, an access point, a base station, a communication management device, a router, a switch, and/or a controller.

It is contemplated that a digital device may include hardware logic such as one or more of the following: (i) processing circuitry; (ii) one or more communication interfaces such as a radio (e.g., component that handles the wireless data transmission/reception) and/or a physical connector to support wired connectivity; and/or (iii) a non-transitory computer-readable storage medium (e.g., a programmable circuit; a semiconductor memory such as a volatile memory and/or random access memory “RAM,” or non-volatile memory such as read-only memory, power-backed RAM, flash memory, phase-change memory or the like; a hard disk drive; an optical disc drive; etc.) or any connector for receiving a portable memory device such as a Universal Serial Bus “USB” flash drive, portable hard disk drive, or the like.

Herein, the terms “logic” (or “logic unit”) are generally defined as hardware and/or software. For example, as hardware, logic may include a processor (e.g., a microcontroller, a microprocessor, a CPU core, a programmable gate array, an application specific integrated circuit, etc.), semiconductor memory, combinatorial logic, or the like. As software, logic may be one or more software modules, such as executable code in the form of an executable application, an application programming interface (API), a subroutine, a function, a procedure, an object method/implementation, an applet, a servlet, a routine, source code, object code, a shared library/dynamic load library, or one or more instructions. These software modules may be stored in any type of a suitable non-transitory storage medium, or transitory computer-readable transmission medium (e.g., electrical, optical, acoustical or other form of propagated signals such as carrier waves, infrared signals, or digital signals).

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

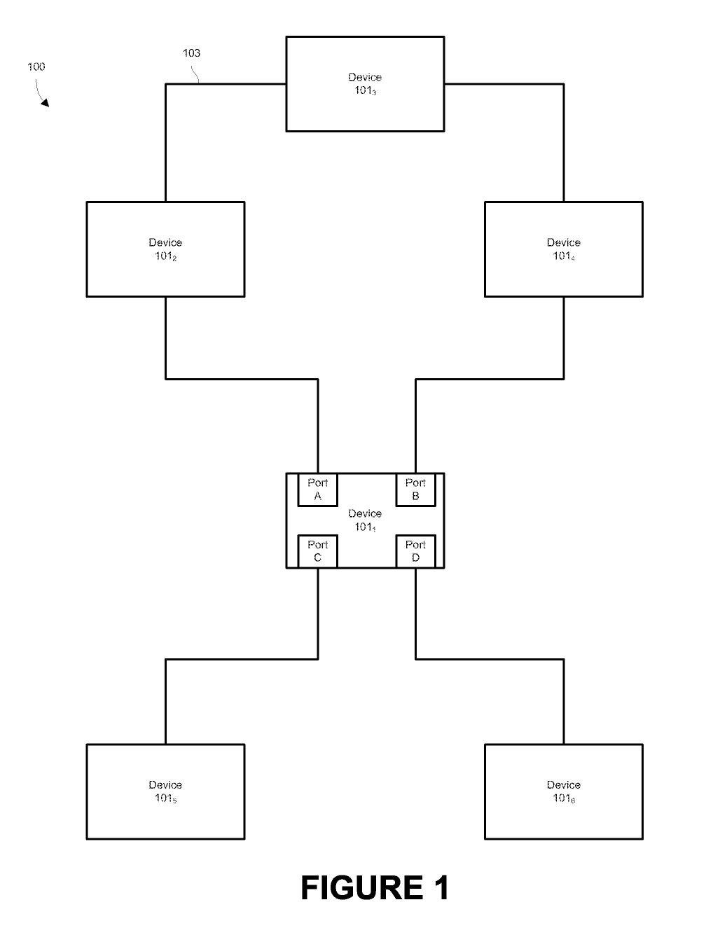

FIG. 1 shows a block diagram example of a network system 100 in accordance with one or more embodiments. The network system 100, as illustrated in FIG. 1, is a digital system that may include a plurality of network devices 101₁-101 _{N} (where N>2). The network devices 101₁-101_{N} may be connected or otherwise associated through corresponding wired and/or wireless connections 103. In one embodiment, the devices 101₁-101_{N} may be connected through a switching fabric. In this embodiment, the devices 101₁-101_{N} may include one or more switches or other networking devices that are capable of interconnecting the devices 101₁-101_{N}. Each element of the network system 100 will be described below by way of example. In one or more embodiments, the network system 100 may include more or less components than shown in FIG. 1. These additional components may be connected to other components within the network system 100 via wired and/or wireless connections 103.

The network devices 101₁-101_{N} may be any device that can interconnect with other network devices 101₁-10_{N} to transmit and receive data over the wired and/or wireless connections 103. For example, one or more of the devices 101₁-101_{N} may be a wireless access point, a network switch, a desktop computer, a laptop computer, a tablet computer, a personal digital assistant (PDA), a telephony device, or any other network capable digital device. In some embodiments, one or more of the network devices 101₁-101_{N} may be configured to operate one or more virtual access points (VAPs) that allow the devices 101₁-101_{N} to be segmented into multiple broadcast domains. In one embodiment, each VAP may apply different wireless settings to separate sets of associated devices 101₁-101_{N}.

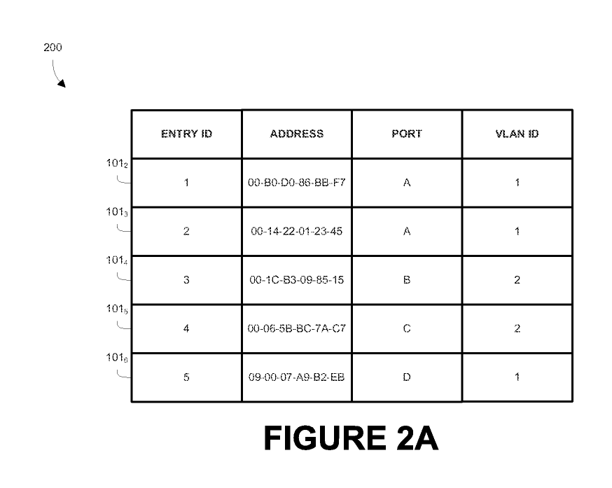

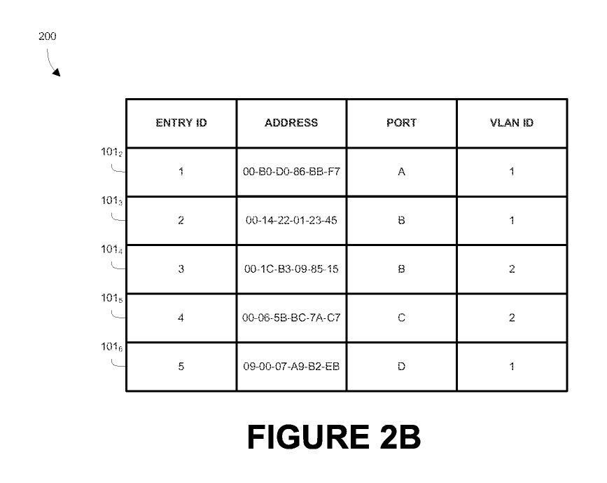

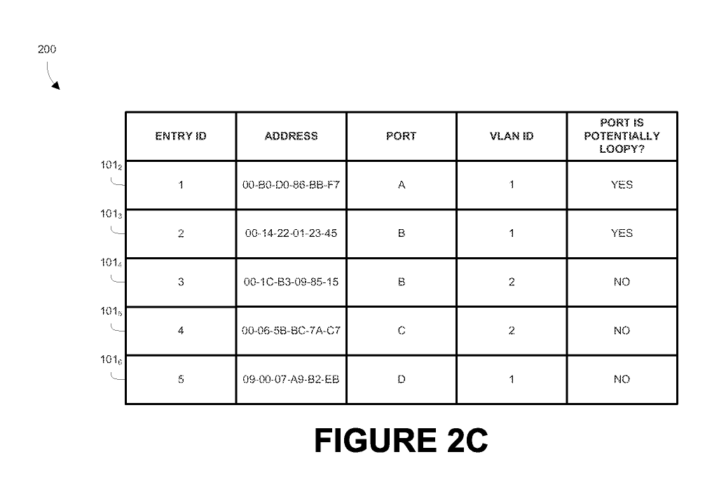

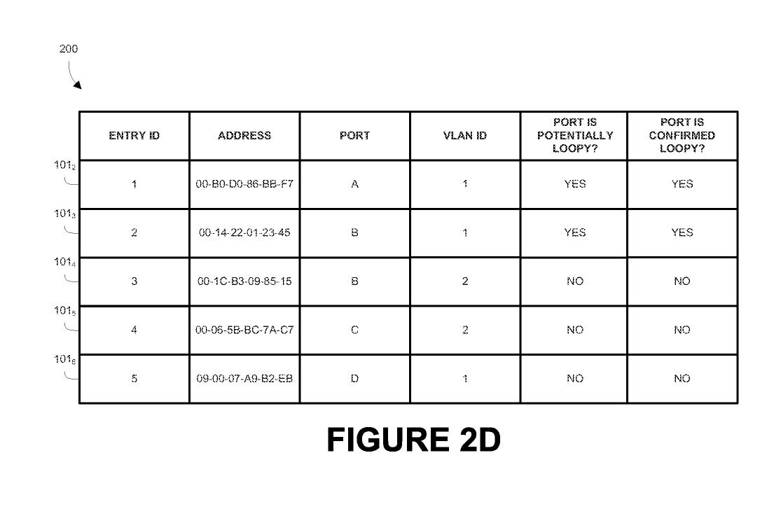

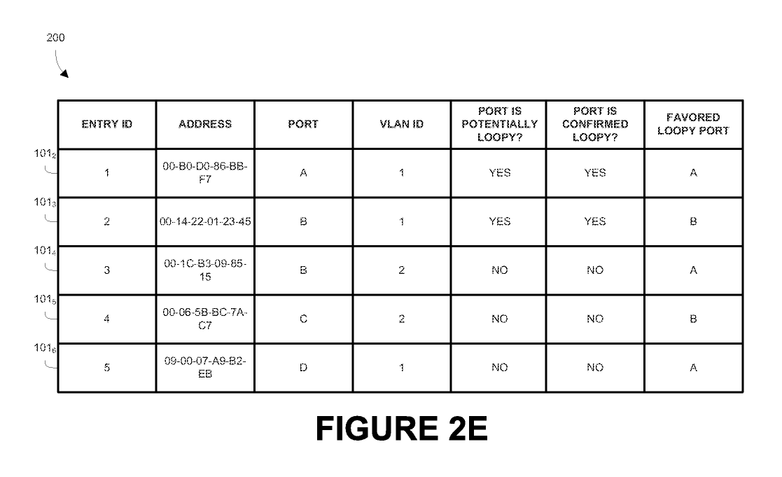

In one embodiment, the network devices 101₁-101_{N} may communicate through ports on each device 101₁-101_{N}. For example, as shown in FIG. 1, the device 101₁ includes ports A-D. A port is an application-specific or process-specific software construct serving as a communications endpoint in a device's 101₁-101_{N} host operating system. A port may be associated with an address of the device 101 ₁-101_{N} (e.g., a media access control (MAC) address and/or an Internet Protocol (IP) address). In one embodiment, each of the devices 101₁-101_{N} may include a bridge table with one or more entries corresponding to other devices 101₁-101_{N} in the network system 100. For example, a bridge table for the device 101₁ may include entries corresponding to one or more of the devices 101₂-101_{N} in the network system 100. The entries indicate an address for one or more of the devices 101₂-101_{N} in the network system 100 and a port number upon which the associated devices 101₂-101_{N} are reachable/accessible. For example, FIG. 2A shows an exemplary bridge table 200 for the device 101₁ with entries 1-5 corresponding to the devices 101₂-101₆, respectively. As shown, each entry 1-5 in the bridge table 200 includes an address (e.g., a MAC address) and a port A-D on the device 101₁ through which a corresponding device 101₂-101₆ is reachable. Based on these entries, the network device 101₃, which is associated with the MAC address “00-14-22-01-23-45”, is reachable through port A on the device 101₁.

In one embodiment, the entries in the bridge table 200 may be updated based on changing network conditions. For example, entry 2 in the table 200 corresponding to the device 101₃ may be changed from port A to port B as shown in FIG. 2B. This movement from port A to port B may be instigated by receipt of a packet originating from the device 101₃ on port B. In some embodiments, these moves in the bridge table 200 may be caused by a data path loop in the network system 100. As will be described in further detail below, these data path loops may cause the network system 100 to be unusable as broadcast storms develop through repeated transmission of the same data packets through the network system 100.

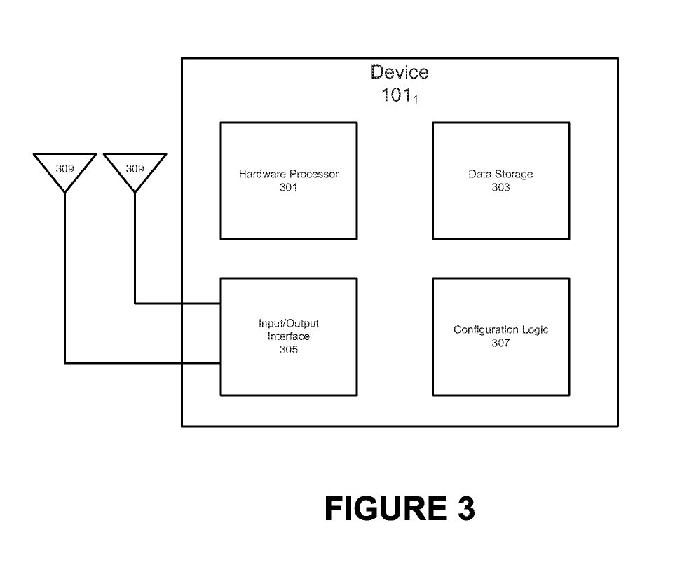

FIG. 3 shows a component diagram of the network device 101₁ according to one embodiment. In other embodiments, the devices 101₂-101 _{N} may include similar or identical components to those shown and described in relation to the device 101₁. As shown in FIG. 3, the device 101₁ may comprise one or more of: a hardware processor 301, data storage 303, an input/output (I/O) interface 305, and device configuration logic 307. Each of these components of the device 101₁ will be described in further detail below.

The data storage 303 of the device 101₁ may include a fast read-write memory for storing programs and data during performance of operations/tasks and a hierarchy of persistent memory, such as Read Only Memory (ROM), Erasable Programmable Read Only Memory (EPROM,) and/or Flash memory for example, for storing instructions and data needed for the startup and/or operation of the device 101₁. In one embodiment, the data storage 303 is a distributed set of data storage components. The data storage 303 may store data that is to be transmitted from the device 101₁ or data that is received by the device 101₁. For example, the data storage 303 of the device 101₁ may store data to be forwarded to the devices 101₂-101 _{N}.

In one embodiment, the I/O interface 305 corresponds to one or more components used for communicating with the devices 101₂-101_{N} via wired or wireless signals. The I/O interface 305 may include a wired network interface such as an IEEE 802.3 Ethernet interface and/or a wireless interface such as an IEEE 802.11 WiFi interface. The I/O interface 305 may communicate with the devices 101₂-101_{N} over corresponding wired and/or wireless channels/connections 103 in the network system 100. In one embodiment, the I/O interface 305 facilitates communications between the device 101₁ and one or more of the devices 101₂-101 _{N} through a switching fabric. In one embodiment, the switching fabric includes a set of network components that facilitate communications between multiple devices 101₁-101_{N}. For example, the switching fabric may be composed of one or more switches, routers, hubs, etc. These network components that comprise the switching fabric may operate using both wired and wireless mediums. In one embodiment, one or more of the devices 101₁-101_{N} may compose the switching fabric.

In some embodiments, the I/O interface 305 may include one or more antennas 309 for communicating with the devices 101₂-101 _{N} and/or other wireless devices in the network system 100. For example, multiple antennas 309 may be used for forming transmission beams to one or more of the devices 101₂-101_{N} through adjustment of gain and phase values for corresponding antenna 309 transmissions. The generated beams may avoid objects and create an unobstructed path to the devices 101₂-101_{N}.

In one embodiment, the I/O interface 305 may transmit data packets to one or more devices 101₂-101_{N} through corresponding ports A-D on the device 101₁. The choice of port A-D may be based on a bridge table associated with the device 101₁ as described above. For example, in the example bridge table 200 shown in FIG. 2A, entry 2 indicates that the device 101₃ may be reachable through port A on the device 101₁. Based on this association in the bridge table 200, transmissions of data packets from the device 101₁ to the device 101₃ may be made through port A on the device 101₁. Further, based on entry 2 in the bridge table 200, the device 101₁ expects to receive packets from the device 101₃ on port A. Receipt of a packet from the device 101₃ on another port of the device 101₁ may cause the bridge table to be updated.

In one embodiment, the device configuration logic 307 includes one or more functional units implemented using firmware, hardware, software, or a combination thereof for configuring parameters associated with the device 101₁. For example, the device configuration logic 307 may be configured to allow the device 101₁ to update entries in an associated bridge table. For example, as shown in FIGS. 2A and 2B, the port for entry 2 in the bridge table 200 may be changed from port A to port B. In one embodiment, the device configuration logic 307 may facilitate this change. In other embodiments, the device configuration logic 307 may assist in accepting and rejecting data packets received on ports of the device 101₁ as will be described in greater detail below.

In one embodiment, the hardware processor 301 is coupled to the data storage 303, the I/O interface 305, and the device configuration logic 307. The hardware processor 301 may be any processing device including, but not limited to a MIPS/ARM-class processor, a microprocessor, a digital signal processor, an application specific integrated circuit, a microcontroller, a state machine, or any type of programmable logic array. The hardware processor 301 may work in conjunction with one or more components to perform the operation of the network device 101₁.

As described above, the other devices 101₂-101_{N} may be similarly configured as described above in relation to the device 101₁. For example, the devices 101₂-101_{N} may comprise a hardware processor 301, data storage 303, an input/output (I/O) interface 305, and device configuration logic 307 in a similar fashion as described above in relation to the device 101₁.

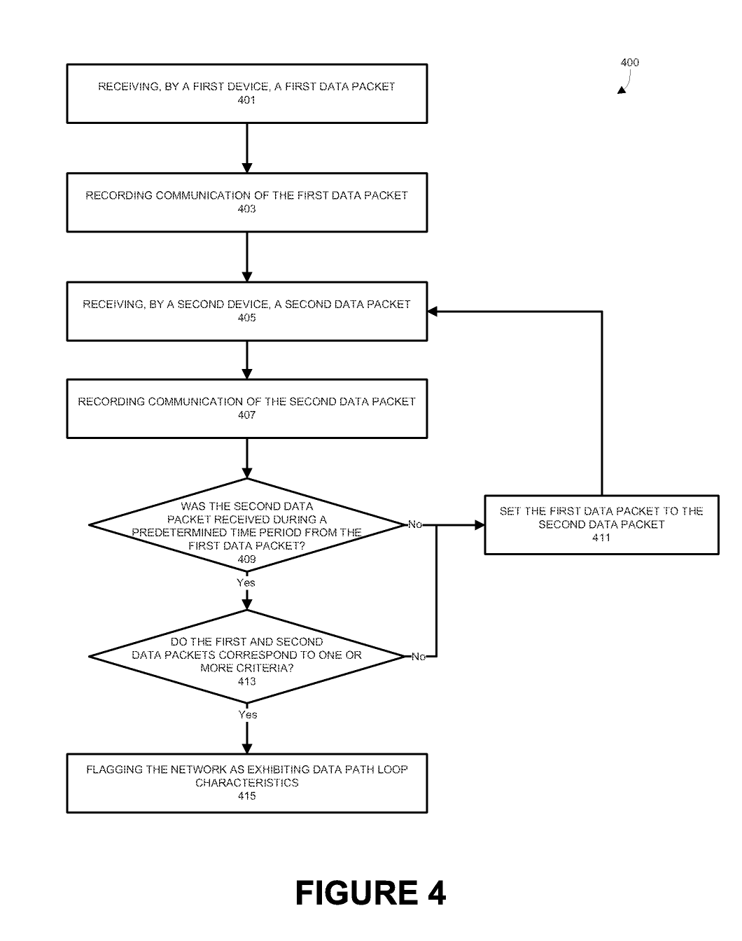

Turning now to the operation of the devices 101₁-101_{N}, FIG. 4 shows a method 400 for detecting characteristics of a data path loop in the network system 100 according to one embodiment. A data path loop may be defined as a communication path from a first port of a device 101₁-101_{N} to a second port of the same device 101₁-101_{N} through one or more other devices 101₁-101_{N}. For example, in the network system 100 shown in FIG. 1, a data path loop may exist between the ports A and B on the device 101₁. In this example, a broadcast packet may be transmitted through port A on the device 101₁ to the devices 101₂ and 101₃ based on entries in the bridge table 200 shown in FIG. 2A. Upon receipt, each of the devices 101₂ and 101₃ may broadcast the data packet to other entities associated with or otherwise coupled to the devices 101₂ and 101₃. In the configuration shown in FIG. 1, the device 101₄ may receive the packet from the device 101₃. The device 101₄ may thereafter transmit the packet to the device 101₁ through port B of the device 101₁. As described, movement of the broadcast packet from port A of the device 101₁ to port B of the device 101₁ via the devices 101₂, 101₃, and 101₄ represents a data path loop. This data path loop may result in a packet storm causing the network system 100 to be unusable as the same packet may be repeatedly forwarded between ports A and B through the network system 100. The method 400, as will be described in greater detail below, may detect characteristics of a data path loop for a device 101 and/or the network system 100 such that the data path loop may be later verified and/or handled. In one embodiment, characteristics of a data path loop, which are detected by the method 400, may include data that is sent on one port of a device 101 and received on another port of the same device 101 as illustrated above.

The method 400 may be performed by one or more components in the network system 100. For example, the method 400 may be performed by one or more of the devices 101₁-101_{N}. In one embodiment, one or more of the devices 101₁-101_{N} may be a network controller and/or a master network controller in the network system 100. This master network controller in the network system 100 may perform one or more of the operations of the method 400 in conjunction with one or more of the devices 101₁-101_{N}.

Although described in relation to the device 101₁, the method 400 may be similarly performed in relation to any other device 101₂-101_{N} in the network system 100. Accordingly, use of the device 101₁ to describe the method 400 is merely illustrative.

In one embodiment, the method 400 may begin at operation 401 with the receipt by the device 101₁ of a first data packet from another device 101₂-101_{N} in the network system 100. For example, the device 101₁ may receive the first data packet originating from the device 101₃. A data packet may refer to a message or any segment of data that may be transferred through a digital network infrastructure. For example, a data packet may refer to a data unit transmitted at the network layer (level 3) of the Open Systems Interconnection (OSI) model. However, in other embodiments, a data packet may refer to a different segment of data. In one embodiment, the first data packet received at operation 401 may be received through the input/output interface 305 and processed by the hardware processor 301.

Following receipt of a first data packet at operation 401, operation 403 stores data related to the first data packet. The stored data may describe the first data packet itself (e.g., a hash value for the received data packet, a signature of the first data packet, and/or the entire first data packet) and/or attributes describing how the first data packet was transmitted/received. For example, the attributes describing how the first data packet was transmitted/received may include the MAC and/or IP address of the device 101 the first data packet originated from (e.g., the device 101₃), a port the first data packet was received on (e.g., port A), a port the first data packet was transmitted on (e.g., a port on the device 101₃), a virtual local area network (VLAN) the first data packet was transported within, etc. In one embodiment, this data may be stored in the data storage 303 on the device 101₁. The data stored at operation 403 may be stored for a predefined amount of time before being cleared from memory. For example, the predefined amount of time may be a loop lifetime, which is the maximum delay for a broadcast packet to return to the originating device 101₁ in the presence of a data path loop. The loop lifetime may be preset by an administrator of the network system 100 or automatically set based on conditions within the network system 100.

At operation 405, the device 101₁ receives a second data packet. Similar to the first data packet, the second data packet may be received from another device 101₂-101_{N} in the network system 100 and data associated with the second data packet may be stored at operation 407.

Following receipt of a first data packet and a second data packet, operation 409 determines whether the second data packet was received during a predefined threshold time period from receipt of the first data packet. The predetermined time period may be preset by an administrator of the network system 100 or automatically set based on current conditions within the network system 100. In one embodiment, the predefined time period may be set to the loop lifetime. In this embodiment, the predetermined time period/loop lifetime may be set based on historical statistics in the network system 100 and estimations regarding the particular time period for a data packet to traverse a data path loop in the network system 100. By ensuring that the second data packet arrived during the loop lifetime, the method 400 filters for data packets that may be the result of a data path loop. If the second data packet is not received during the predefined time period, the method 400 may set the first packet to the second data packet at operation 411 and return to operation 405 to await a new second data packet. When operation 409 determines that the second data packet was received during the predetermined time period relative to receipt of the first data packet, the method 400 may move to operation 413.

At operation 413, data corresponding to the first data packet and data corresponding to the second data packet, which were stored at operations 403 and 407 respectively, are compared to determine if the network system 100 is exhibiting characteristics of a data path loop. For example, data corresponding to the first data packet and data corresponding to the second data packet may be compared against a set of criteria to determine if the network system 100 is exhibiting characteristics of a data path loop. The set of criteria used may vary as described below.

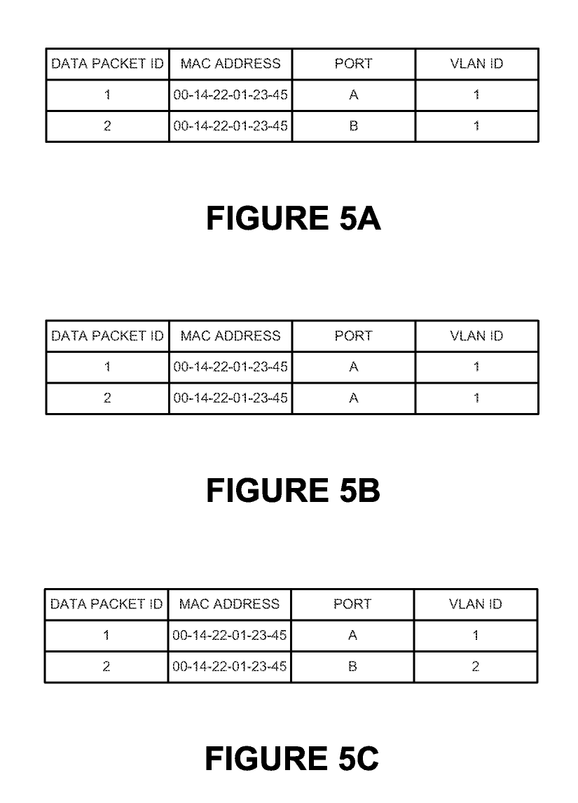

As noted above, in one embodiment, characteristics of a data path loop may include data that is sent on the same port of the device 101₁ and received from the same device 101₂-101_{N} on another port of the device 101₁. Accordingly, the criteria used by operation 413 may include an indication that the first and second data packets were received from the same device 101₂-101_{N} on the same data port of the device 101₁. FIG. 5A shows example data stored for a first data packet and a second data packet. As shown, the first data packet originated from the device 101₃ with the MAC address “00-14-22-01-23-45” on port A of the device 101₁ and within VLAN 1. In contrast, the second data packet originated from the device 101₃ with the MAC address “00-14-22-01-23-45” on port B of the device 101₁ and within VLAN 1. Accordingly, both the first and second packets were received from the device 101₃ over VLAN 1 but over different ports of the device 101₁ (i.e., ports A and B). Since the first and second data packets were received on different ports, but from the same device and on the same VLAN, operation 413 may determine that the network system 100 exhibits characteristics of a data path loop. The data path loop may be associated with ports A and B on the device 101₁.

FIG. 5B shows data corresponding to another set of first and second data packets received by the device 101₁ and analyzed by the method 400. In this example, both the first and second data packets originated from the device 101₃ with the MAC address “00-14-22-01-23-45” on port A of the device 101₁ and within VLAN 1. Accordingly, both the first and second data packets were received on the same port of the device 101₁ and operation 413 may determine that the network system 100 does not exhibit characteristics of a data path loop based on this data.

FIG. 5C shows data corresponding to yet another set of first and second data packets received by the device 101₁ and analyzed by the method 400. As shown, the first data packet originated from the device 101₃ with the MAC address “00-14-22-01-23-45” on port A of the device 101₁ and within VLAN 1. In contrast, the second data packet originated from the device 101₃ with the MAC address “00-14-22-01-23-45” on port B of the device 101₁ and within VLAN 2. Although the first and second packets were received from the device 101₃ over different ports of the device 101₁ (i.e., ports A and B), operation 413 may determine that the network system 100 does not exhibit characteristics of a data path loop since the packets were on different VLANs. As shown in the example, since the first and second packets were effectively on different networks (i.e., different VLANs), the movement of packets between ports does not indicate characteristics of a data path loop.

In one embodiment, operation 413 may determine that the network system 100 exhibits characteristics of a data path loop by comparing the first data packet and the second data packet to determine a match between the data packets (i.e., the first and second data packets are identical). This comparison may be a direct bit-by-bit comparison of the two data packets or may be performed based on hash values of each data packet (e.g., MD5 hashes of each data packet). Upon determination that the first and second data packets are identical, operation 413 may conclude that the network system 100 exhibits characteristics of a data path loop since the first data packet was likely forwarded through one or more devices 101₂-101_{N} and back to the originating device 101₁. In some embodiments, this comparison of the first and second data packets may be performed in conjunction with an examination of the origin of each data packet and associated receiving port as described above. Accordingly, the method 400 may use each of these criteria in determining whether the network system 100 contains characteristics of a data path loop.

In one embodiment, operation 413 may determine that the network system 100 exhibits characteristics of a data path loop based on a mapping of a device 101 from which the first data packet was received. For example, using the example provided above, the second data packet may be received from the device 101₃ on port B. However, according to the bridge table 200 in FIG. 2A, the device 101₃ is associated with the port A. Based on this inconsistency in port mapping for the originating device 101₃, operation 413 may compare the first and second data packets to determine a match as described above (e.g., using hash value or a bit-by-bit comparison). Upon determining that the second data packet was received on a port that is inconsistent with an entry in an associated bridge table and a match between the first and second data packets, operation 413 may determine the existence of a data path loop between the ports A and B.

In another embodiment, operation 413 may determine whether the network system 100 contains characteristics of a data path loop based on repeated movement of devices 101₂-101_{N} in a bridge table of the device 101₁. For example, as shown in FIG. 5A, the device 101₃ transmits a first data packet that is received on port A of the device 101₁. Based on receipt of this first data packet, the bridge table may be updated to reflect that the device 101₃ is accessible through port A on the device 101₁ as shown in FIG. 2A. Subsequent to receipt of the first data packet, the device 101₃ transmits a second data packet that is received on port B of the device 101₁ as shown in FIG. 5B. This change in port may yield a change in a bridge table entry as shown in FIG. 2B. Repeated movement of the device 101₃ between ports in the bridge table associated with the device 101₁ may result in operation 413 determining that the network system 100 contains characteristics of a data path loop. In one embodiment, movement of the device 101₃ a predefined amount of times (e.g., ten times) during a predefined time period (e.g., the loop lifetime) may result in operation 413 determining that the network system 100 contains characteristics of a data path loop. The predefined amount of times and predefined time period may be set by a network administrator or be automatically set based on performance and configuration of the network system 100.

In some embodiments, repeated movement of a device 101₂-101_{N} in a bridge table of the device 101₁ may be used in conjunction with other criteria described above at operation 413. Accordingly, the determination of whether the network system 100 exhibits characteristics of a data path loop may be performed based on several criteria.

Following detection of characteristics of a data path loop at operation 413, the method 400 may move to operation 415 to flag the network system 100, one or more devices 101₁-101_{N}, and/or one or more ports on one or more VLANs in the network system 100 as having characteristics of a data path loop. In one embodiment, operation 415 may flag the ports on the device 101₁ as exhibiting characteristics of a data path loop by modifying values in a bridge table. For example, as shown in FIG. 2C, ports A and B on VLAN 1 in the bridge table 200 have been marked as exhibiting characteristics of a data path loop (e.g., possibly loopy) based on the data packets described in FIG. 5A. Subsequent to the flagging at operation 415, additional analysis may be performed on the network system 100 and/or on one or more potentially loopy ports as described in greater detail below.

As noted above in relation to FIG. 5C, potentially loopy ports may be relative to a particular VLAN associated with the loop. For example, a loop between two ports for packets on a first VLAN may not be indicative that the same ports are looped for packets tagged with a second VLAN. Accordingly, as shown in FIG. 2C, the port B is loopy on VLAN 1, but not on VLAN 2.

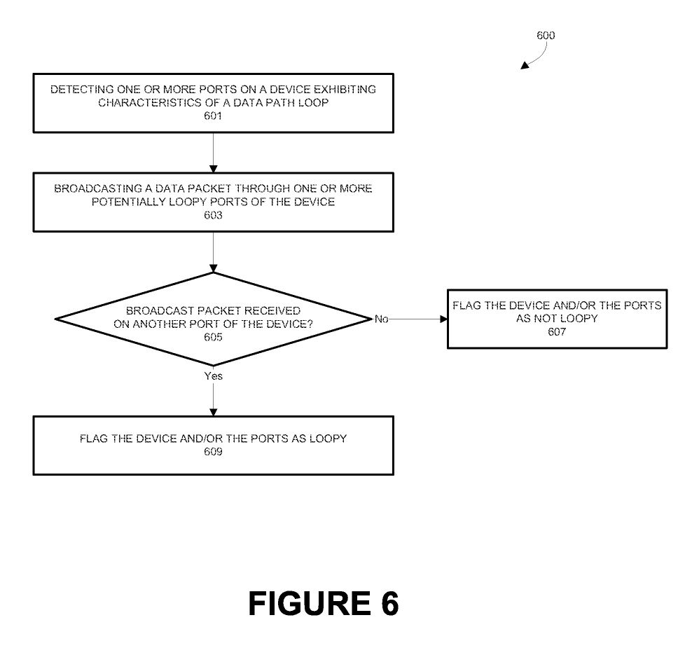

FIG. 6 shows a method 600 for confirming that the network system 100 includes a data path loop according to one embodiment of the invention. The method 600 may be performed after characteristics of a data path loop were detected on the network system 100. In this embodiment, the method 400 has flagged the network system 100, one or more device 101₁-101_{N}, and/or one or more sets of ports as exhibiting characteristics of a data path loop and the method 600 may be used to determine/confirm, with a greater level of confidence, whether the network system 100 indeed contains a data path loop.

The method 600 may be performed by one or more components in the network system 100. For example, the method 600 may be performed by one or more of the devices 101₁-101_{N}. In one embodiment, one or more of the devices 101₁-101_{N} may be a network controller and/or a master network controller in the network system 100. This master network controller in the network system 100 may perform one or more of the operations of the method 600 in conjunction with one or more of the devices 101₁-101_{N}.

In one embodiment, the method 600 may begin at operation 601 with the detection that the network system 100 exhibits characteristics of a data path loop. The detection may include a device 101₁, a set of ports on the device 101₁, and/or a VLAN associated with the characteristics of the data path loop. This detection at operation 601 may be performed by the method 400 after monitoring packet transmissions on the network system 100. For example, operation 601 may detect that ports A and B on the device 101₁ operating on VLAN 1 exhibit characteristics of a data path loop based on monitored packets on ports A and B of the device 101₁ as described above.

In response to detection of data path loop characteristics, the method 600 may move to operation 603 to begin the process of determining whether a data path loop exists in the network system 100. At operation 603, the device 101₁ in which characteristics of a data path loop were detected may broadcast a data packet through each port on the device 101₁. For example, the device 101₁ may broadcast a data packet through the ports A-D such that the data packet is transmitted to each other device 101₁-101_{N} in the network system 100. In one embodiment, the broadcast packet may only be sent through ports and VLANs that were flagged as exhibiting characteristics of a data path loop (e.g., ports A and B on VLAN 1 as shown in FIG. 2C). As noted above, a data packet may refer to a message or any segment of data that may be transferred through a digital network infrastructure. Although described in relation to broadcasting, in other embodiments, the data packet may be multicast at operation 603 to a specific multicast receiver group within the network system 100. For example, the data packet may be multicast only to the devices 101₂, 101₃, and 101₄, which is the segment of the network system 100 which exhibited characteristics of a data path loop (i.e., devices 101 corresponding to loopy ports A and B). In another embodiment, the data packet may only be multicast through devices 101 on the same VLAN that has ports marked as potentially loopy. In the example shown in FIG. 2C, the multicast would include the device 101₃ that has a port operating on VLAN 1.

Following the broadcast of a data packet at operation 603, operation 605 determines if the data packet is received on another port of the device 101₁ and on the same VLAN. In one embodiment, the data packet broadcast at operation 603 may be a specially generated data packet. This specially generated data packet may be uniquely identified by the device 101₁ as a test packet at operation 605.

In one embodiment, the specially generated data packet may include data indicating the port through which the packet was transmitted. This transmitting port information may make it easy to determine which ports are potentially involved in a data path loop. Upon determining that the received data packet is not identical to the broadcast data packet, the method 600 may flag the network system 100 as not containing a data path loop at operation 607. In this embodiment, the characteristics of a data path loop exhibited by the network system 100 and one or more devices 101₁-101_{N} in the network system 100 may be attributed to configuration changes amongst the devices 101₁-101_{N} or other non-loop factors.

In contrast, upon determining that the broadcast data packet is identical to the newly received data packet at operation 605, the method 600 may move to operation 609 to flag the network system 100, the device 101₁, one or more ports on the device 101₁, and/or a corresponding VLAN as containing a data path loop. In the examples provided above, operation 609 may flag ports A and B on the device 101₁ operating on VLAN 1 as having a data path loop (i.e., loopy). In one embodiment, operation 607 and 609 may flag ports A and B on VLAN 1 in a bridge table as shown in FIG. 2D. In this embodiment, the ports A and B on VLAN 1 are both flagged as loopy at operation 609. In one embodiment, the detected data path loop may be handled as will be described in further detail below.

By first detecting characteristics of a data path loop and thereafter confirming the presence of a loop, the methods 400 and 600 ensure that anomalies in data packet and/or port movement in the network system 100 are not the product of configuration changes in the network system 100, but are instead the result of data path loops. By more intelligently identifying data path loops as described above, the network system 100 may reduce false positives. These detected data path loops may be intelligently and efficiently handled as will be described in further detail below.

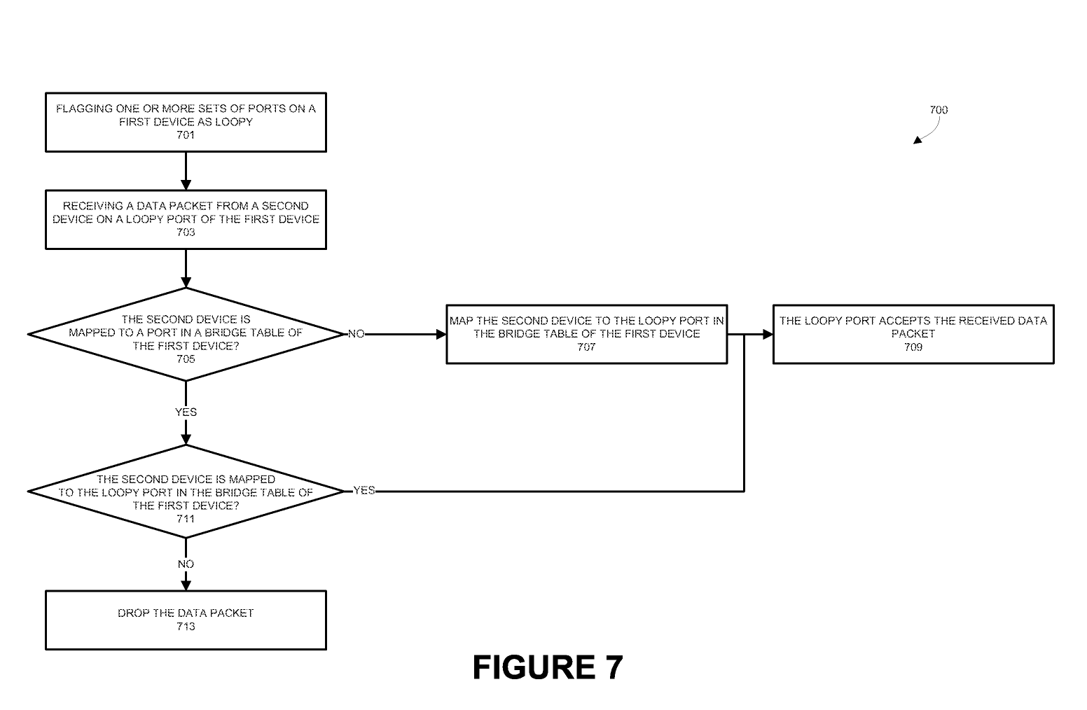

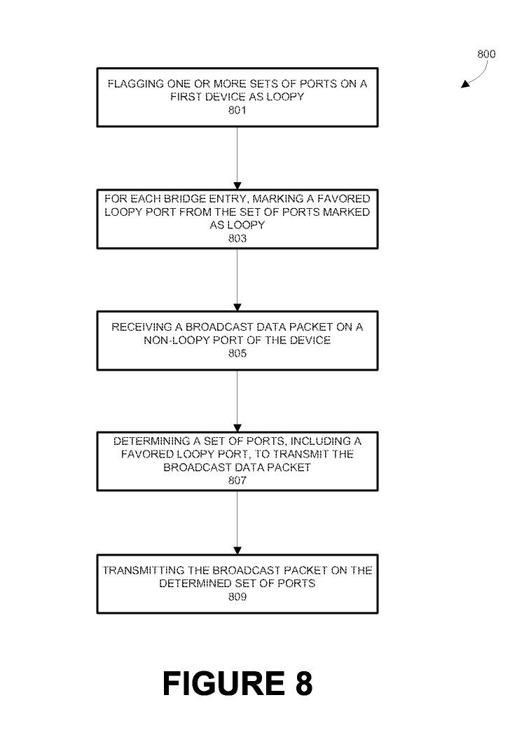

Turning now to FIGS. 7 and 8, embodiments directed to configuring the devices 101₁-101_{N} to operate in an environment with data path loops will now be described. Embodiments are directed to a new configuration of ports that form a part of a data loop. Examples include configuring one or more of the devices 101₁-101_{N} to forward or refrain from forwarding data packets based on the port on which the packets were received and characteristics of the received packets. Characteristics of the received packets may include, but are not limited to, a sender of the received packet, a target device of the received packet, or an application corresponding to the received packet. Several example methods for handling data packets in the presence of a data path loop are described below.

FIG. 7 shows a method 700 for handling communications received on a loopy port on a device 101₁-101_{N} according to one embodiment. For instance, in the examples provided above, a data path loop was detected between ports A and B on the device 101₁ operating on VLAN 1. Accordingly, the method 700 may handle packet transmissions received on these ports A and B on VLAN 1 such that the detected data path loop does not result in a broadcast storm or other undesirable effects on the network system 100. As will be described in greater detail below, the method 700 allows the port on which a data packet is received to determine whether or not the data packet is to be forwarded to one or more of the devices 101₁-101_{N}.

The method 700 may be performed by one or more devices in the network system 100. For example, the method 700 may be performed by one or more of the devices 101₁-101_{N}. In one embodiment, one or more of the devices 101₁-101_{N} may be a network controller and/or a master network controller in the network system 100. This master network controller in the network system 100 may perform one or more of the operations of the method 700 in conjunction with one or more of the devices 101₁-101_{N}.

The method 700 may commence at operation 701 with the detection of a data path loop between a set of ports on the device 101₁. In one embodiment, the detection of a data path loop at operation 701 may be performed by the methods 400 and 600 described above. For instance, using the examples provided above, characteristics of a data path loop between the ports A and B on the device 101₁ operating on VLAN 1 may be detected using the method 400. The data path loop between the ports A and B on VLAN 1 may thereafter be confirmed using the method 600. The data path loop may be recorded in a bridge table associated with the device 101₁ as shown in FIG. 2D or in another data structure. For example, the entries related to the ports A and B on VLAN 1 in the bridge table 200 are designated as loopy as show in FIG. 2D based on the performance of the method 600.

Following detection of a data path loop between a set of ports, operation 703 awaits receipt of a new data packet on a port that has been designated as loopy. For example, a data packet may be received from the device 101₃ on port B of the device 101₁. Using the example scenario provided above and shown in the bridge table 200 in FIG. 2D, port B has previously been designated as loopy. In one embodiment, the data packet must be received on a VLAN that has been designated along with the set of ports as loopy (e.g., VLAN 1 for ports A and B).

At operation 705, the data packet received on the loopy port B is compared with entries within a bridge table. In one embodiment, the lookup at operation 705 includes a comparison of the MAC address of the device 101₁-101_{N} that transmitted the data packet. In the example provided above, the data packet originated from the device 101₃. Accordingly, the MAC address of the device 101₃ may be compared against entries in a bridge table associated with the device 101₁. When the MAC address of the device 101₃ that transmitted the data packet fails to match with an entry in the bridge table, the method 700 moves to operation 707 to add an entry for the device 101₃ in the bridge table and associate the device 101₃ with the port the data packet was received on. The received data packet may be subsequently delivered to and/or accepted by the loopy port at operation 709.

Upon operation 705 matching the device 101₃ that transmitted the data packet with an entry in the bridge table, the method 700 moves to operation 711. In one embodiment, operation 711 determines whether the device 101₃ is mapped in the bridge table with the loopy port upon which the data packet was received. Upon determining a match between the device 101₃ that transmitted the data packet and the loopy port upon which the data packet was received, the method 700 moves to operation 709 to accept the data packet by the loopy port. In some embodiments, operation 711 may further analyze the received data packet based on a set of criteria to determine if the loopy port should accept the data packet at operation 709. For instance, operation 711 may compare one or more characteristics of the data packet against attributes in the bridge table. In one embodiment, the attributes may include a software port on the transmitting device 101₁-101_{N} from which corresponding port on the receiving device 101₁-101_{N} accepts data packets. For example, port A on the device 101₁ may accept all data from port X on the device 101₃ and port B on the device 101₁ may accept all data from port Y on the device 101₃. In other embodiments, separate sets of attributes and criteria may be used at operation 711 to determine whether a port on a device 101₁-101_{N} accepts/processes or rejects/discards a data packet from another device 1011-101_{N}. The set of criteria used by each port on a device 101₁-101_{N} to accept or reject data packets may be mutually exclusive from the set of criteria used by another port on the same device 101₁-101_{N}. In one embodiment, the sets of criteria used by a set of ports may be configured in response to determining a data path loop between the set of ports.

When operation 711 fails to match the device 101₃ that transmitted the data packet and the loopy port upon which the data packet was received, the loopy port may decline receipt and/or drop the data packet at operation 713. By dropping data packets on loopy ports that are not mapped to a transmitting device 101₁-101_{N} while allowing data packets to reach their intended destination when a proper match is detected, the method 700 prevents data packets from being continually duplicated and broadcast throughout a loopy segment of the network system 100 without requiring loopy ports to be disabled entirely. Moreover, by not disabling ports, load balancing between ports may be achieved by allowing each loopy port to continue to process packets from designated devices 101₁-101_{N}. Accordingly, in contrast to traditional systems, data packets intended for a loopy port are not entirely dropped, but instead are intelligently handled to balance traffic on a set of loopy ports.

Turning now to FIG. 8, a method 800 for handling transmission of a broadcast packet received by a device 101₁-101_{N} in which a set of loopy ports have been detected will now be described. For instance, in the examples provided above, a data path loop was detected between ports A and B on the device 101₁operating on VLAN 1 using the methods 400 and 600. In this example, the method 800 may handle broadcast packets from the devices 101₅ and 101₆ received by the device 101₁ operating on VLAN 1. Traditionally, the device 101₁ would transmit a received broadcast packet on each port A-D of the device 101₁ (excluding the port on which the broadcast packet was received). However, since a data path loop exists between the ports A and B on the device 101₁, transmitting the broadcast packet on all ports would yield the duplication of the packet in the loopy portion of the network system 100. Accordingly, in one embodiment, the method 800 selectively and intelligently transmits broadcast packets through loopy ports to ensure that the broadcast packet is not duplicated in a loopy portion of the network system 100 and thus preventing a potential broadcast storm.

The method 800 may be performed by one or more devices in the network system 100. For example, the method 800 may be performed by one or more of the devices 101₁-101_{N}. In one embodiment, one or more of the devices 101₁-101_{N} may be a network controller and/or a master network controller in the network system 100. This master network controller in the network system 100 may perform one or more of the operations of the method 800 in conjunction with one or more of the devices 101₁-101_{N}.

The method 800 may commence at operation 801 with the detection of a data path loop between a set of ports on the device 101₁ and optionally on a particular VLAN. In one embodiment, the detection of a data path loop at operation 801 may be performed by the methods 400 and 600 described above. For instance, using the examples provided above, characteristics of a data path loop between the ports A and B on the device 101₁ operating on VLAN 1 may be detected using the method 400. The data path loop between the ports A and B on VLAN 1 may thereafter be confirmed using the method 600. The data path loop may be recorded in a bridge table associated with the device 101₁ as shown in FIG. 2D or in another data structure. For example, the entries related to the ports A and B on VLAN 1 in the bridge table 200 are designated as loopy as show in FIG. 2D based on the performance of the method 600.

Upon detection of a data path loop, operation 803 may populate a favored loopy port field for each entry in a bridge table associated with the device 101₁ in which a set of loopy ports were detected. In one embodiment, the favored loopy port field indicates which port in a set of loopy ports will be used for transmitting broadcast packets. For instance, in the examples provided above, ports A and B on the device 101₁ operating on VLAN 1 have been designated as loopy based on performance of the methods 400 and 600. Based on this determination a favored loopy port field is generated in the bridge table 200 as shown in FIG. 2E. For each entry in the bridge table, operation 803 assigns either port A or port B. Although not shown, in some embodiments this assignment of a favored loopy port may indicate a particular VLAN for which the loopy ports are operating. Operation 803 may utilize multiple separate techniques, criteria, and/or factors to assign loopy ports to entries and devices 101₁-101_{N}. For example, a favored loopy port may be assigned 1) randomly to each entry, 2) based on load on each port, 3) on receipt of a packet with a destination matching an existing bridge entry from a loopy port, the port on which the packet is received may be assigned as the favored loopy port for this destination, 4) hashing on the MAC address in the bridge entry can be performed to select one of the loopy ports as a favored loopy port and 5) upon receipt of a packet if no favored loopy port is identified, the actual destination port may be updated as the favored loopy port for this source device 101₁-101_{N}. In some embodiments, when multiple sets of loopy ports are detected on the device 101₁, a corresponding number of favored loopy ports may be assigned to each entry in the bridge table. In some embodiments, the favored loopy port may be further delineated based on VLAN.

Although described in relation to broadcast and multicast packet transmission, in some embodiments the method 800 may similarly function in relation to unicast transmissions or unknown unicast (e.g., there is no existing bridge entry for the destination device 101 and the normal practice is to flood the packet). For example, upon receipt of a unicast data packet, if the destination device 101₁-101_{N} is on a loopy port, the packet may be forwarded through the favored loopy port of the source device 101₁-101_{N}. If no favored loopy port is identified, the actual destination port may be updated as the favored loopy port for this source device 101₁-101_{N}.

In one embodiment, a favored loopy port may be designated for a device 101 only when a packet is received from that device 101. Upon receipt of the packet, a favored loopy port may be designed for the transmitting device 101 using one or more of the techniques, criteria, and/or factors described above. After assigning a favored loopy port to each entry in a bridge table, a broadcast packet may be received from a device 101₂-101_{N} on a non-loopy port of the device 101₁ at operation 805. For example, the device 101₅ may transmit a broadcast data packet and the broadcast data packet may be received by port C of the device 101₁ at operation 805. Although described in relation to broadcasting, in other embodiments, the data packet may be a multicast data packet.

Based on the received broadcast data packet, operation 807 may determine a set of ports on the device 101₁ to transmit the broadcast data packet. In one embodiment, the set of ports may initially include each port that has not been designated as loopy and was not the port on which the broadcast packet was received. In the example provided above, since the broadcast packet was received from the device 101₅ on port C of the device 101₁, the set initially only includes port D. In addition to non-loopy ports, a favored loopy port associated with the device 101₅ that transmitted the broadcast packet to the device 101₁ may also be added to the set. In the example bridge table provided in FIG. 2E, the favored loopy port for the device 101₅ is port B on the device 101₁. Accordingly, port B is added to the set of ports used to transmit the broadcast packet at operation 807 such that the set includes ports D and B.

Following the construction of a set of ports to transmit the broadcast packet, operation 809 transmits the broadcast packet through this determined set of ports. As described above, the transmission of broadcast data packets is selectively transmitted through a single loopy port. Further, since each device 101₂-101_{N} is intelligently and evenly assigned to one favored port in the set of loopy ports, a single loopy port is not overly utilized and load balancing may be realized across the set of loopy ports. The techniques described above may also ensure that broadcast packets do not cause broadcast storms, packet duplications, and/or excessive port moves in other switching devices present in the loopy part of the network.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components. Also, although the discussion focuses on uplink medium control with respect to frame aggregation, it is contemplated that control of other types of messages are applicable.

Any combination of the above features and functionalities may used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more devices, cause performance of operations comprising:
receiving, on a first port of a first device, a first message originating from a second device;
receiving, on a second port of the first device, a second message originating from the second device;
determining that the first message and the second message, received by the first device:
(a) were received on different ports of the first device; and
(b) originated from the same second device and/or are identical messages;
responsive at least to the determining operation, detecting that a network comprising the first device and the second device has one or more characteristics of a data path loop.

2. The medium of claim 1, wherein the detecting operation is further responsive to determining that a mapping of the second device to a corresponding port of the first device, which is based on packets received by the first device from the second device, is modified more times than a threshold number within a particular period of time.

3. The medium of claim 1, wherein the detecting operation is further responsive to determining that the second message is received on the second port of the first device within a threshold period of time after receiving the first message on the first port of the first device.

4. The medium of claim 1, wherein the determining operation further comprises determining that the first message and second message are identical messages.

5. The medium of claim 1, wherein the determining operation further comprises determining that the first message and the second message originated from the same second device.

6. The medium of claim 1, wherein determining that the first message and the second message originated from the same second device comprises determining that a source MAC address and an originating IP subnet corresponding to the first message and the second message are identical.

7. The medium of claim 1, wherein the first message is different than the second message.

8. A non-transitory computer readable medium comprising instructions which, when executed by one or more devices, cause performance of operations comprising:
receiving, on a first port of a first device, a first broadcast or multicast message originating from a second device;
subsequent to receiving the first broadcast or multicast message, determining that a mapping value for the second device indicates that the second device is mapped to a second port on the first device, the second port being different than the first port;
responsive at least to receiving the first broadcast or multicast message on the first port when the second device is mapped to the second port: comparing the first broadcast or multicast message to a stored second broadcast or multicast message, the second broadcast or multicast message being received from the second device by the first device prior to receiving the first broadcast or multicast message; and
responsive at least to determining that the first broadcast or multicast message and the second broadcast or multicast message are identical, detecting that a network comprising the first device and the second device has one or more characteristics of a data path loop.

9. The medium of claim 8, wherein the operations further comprise storing the second broadcast or multicast message for a particular time period selected based on current network information.

10. The medium of claim 8, wherein the detecting operation is further responsive to determining that the first multicast or broadcast message was received within a threshold period of time after receiving the second multicast or broadcast message.

11. The medium of claim 8, wherein the detecting operation is further responsive to determining that the first broadcast or multicast message and the second broadcast or multicast message originated from the same second device.

12. A non-transitory computer readable medium comprising instructions which, when executed by one or more devices, cause performance of operations comprising:
detecting one or more characteristics associated with a data path loop from a first port of a first device to a second port of the first device via other devices;
responsive to detecting one or more characteristics associated with the data path loop from the first port to the second port:
transmitting a packet on the first port of the first device;
determining whether the packet transmitted on the first port of the first device was received on the second port of the first device;
responsive to determining that the packet transmitted on the first port of the first device was received on the second port of the first device, determining that the data path loop exists between the first port and the second port; and
responsive to determining that the packet transmitted on the first port of the first device was not received on the second port of the first device, determining that the data path loop does not exist between the first port and the second port.

13. The medium of claim 12, wherein detecting the one or more characteristics associated with the data path loop prior to transmitting the packet on the first port comprises:
determining that a mapping value for the second device alternates between indicating that (a) the second device is connected to the first port of the first device and (b) the second device is connected to the second port of the first device.

14. The medium of claim 12, wherein detecting the one or more characteristics associated with the data path loop prior to transmitting the packet on the first port comprises:
determining that a packets received from the second device by the first device have alternated between being received on the first port of the first device and the second port of the first device.

15. A system comprising:
a computer including a hardware processor, the system being configured to perform the operations of:
receiving, on a first port of a first device, a first message originating from a second device;
receiving, on a second port of the first device, a second message originating from the second device;
determining that the first message and the second message, received by the first device:
(a) were received on different ports of the first device; and
(b) originated from the same second device and/or are identical messages;
responsive at least to the determining operation, detecting that a network comprising the first device and the second device has one or more characteristics of a data path loop.

16. The system of claim 15, wherein the detecting operation is further responsive to determining that a mapping of the second device to a corresponding port of the first device, which is based on packets received by the first device from the second device, is modified more times than a threshold number within a particular period of time.

17. A system comprising:
a computer including a hardware processor, the system being configured to perform the operations of:
receiving, on a first port of a first device, a first broadcast or multicast message originating from a second device;
subsequent to receiving the first broadcast or multicast message, determining that a mapping value for the second device indicates that the second device is mapped to a second port on the first device, the second port being different than the first port;
responsive at least to receiving the first broadcast or multicast message on the first port when the second device is mapped to the second port:
comparing the first broadcast or multicast message to a stored second broadcast or multicast message, the second broadcast or multicast message being received from the second device by the first device prior to receiving the first broadcast or multicast message; and
responsive at least to determining that the first broadcast or multicast message and the second broadcast or multicast message are identical, detecting that a network comprising the first device and the second device has one or more characteristics of a data path loop.

18. The system of claim 17, wherein the operations further comprise storing the second broadcast or multicast message for a particular time period selected based on current network information.

19. A system comprising:
a computer including a hardware processor, the system being configured to perform the operations of:
detecting one or more characteristics associated with a data path loop from a first port of a first device to a second port of the first device via other devices;
responsive to detecting one or more characteristics associated with the data path loop from the first port to the second port:
transmitting a packet on the first port of the first device;
determining whether the packet transmitted on the first port of the first device was received on the second port of the first device;
responsive to determining that the packet transmitted on the first port of the first device was received on the second port of the first device, determining that the data path loop exists between the first port and the second port; and
responsive to determining that the packet transmitted on the first port of the first device was not received on the second port of the first device, determining that the data path loop does not exist between the first port and the second port.

20. The system of claim 19, wherein detecting the one or more characteristics associated with the data path loop prior to transmitting the packet on the first port comprises:
determining that a mapping value for the second device alternates between indicating that (a) the second device is connected to the first port of the first device and (b) the second device is connected to the second port of the first device.
